(19) United States
(12) Patent Application Publication
(10) Pub. No.: US 2025/0065851 A1
(43) Pub. Date: Feb. 27, 2025

(54) LOW PROFILE HYDRAULIC LEVELING JACK

(71) Applicant: Lippert Components, Inc., Elkhart, IN (US)

(72) Inventors: Brandon L. LEHMAN, White Pigeon, MI (US); Robert Daniel SLACK, White Pigeon, MI (US); Mark Russell KINDER, Clarks Hill, IN (US)

(21) Appl. No.: 18/813,703

(22) Filed: Aug. 23, 2024

Related U.S. Application Data
(60) Provisional application No. 63/534,233, filed on Aug. 23, 2023.

(51) Int. Cl. B60S 9/12; B60S 9/22; B66F 3/25

(52) U.S. Cl. CPC B60S 9/12; B60S 9/22; B66F 3/25

(57) ABSTRACT

A leveling jack includes a cylinder assembly with a leveling cylinder that is displaceable between a retracted position and an extended position. A footpad is coupled with the leveling cylinder for displacement with the leveling cylinder. A mounting bracket coupled with the cylinder assembly includes mounting legs having apertures therein, and a connecting bracket securable to a structure to be leveled is coupled with the mounting bracket via a connector through the apertures in the mounting bracket.

### CROSS-REFERENCES TO RELATED APPLICATIONS

This application claims the benefit of U.S. Provisional Patent Application No. 63/534,233, filed Aug. 23, 2023, the entire content of which is herein incorporated by reference.

### STATEMENT REGARDING FEDERALLY SPONSORED RESEARCH OR DEVELOPMENT

(Not Applicable)

### BACKGROUND

When a recreational vehicle or trailer is parked for use, it is desirable that the vehicle be leveled and stabilized for the convenience of the inhabitants. Accordingly, it has become common to provide stabilization and leveling systems for recreational vehicles. Commonly, these systems provide multiple leveling jacks (usually four) located on I-beams or the like on opposite corners of the vehicle. A centralized hydraulic system mounted within the vehicle is used to effect leveling and stabilization. The centralized hydraulic system includes a pump, reservoir, and appropriate hydraulic lines connecting the pump to the jacks located at each corner of the vehicle. Such systems are shown in U.S. Pat. Nos. 4,061,309; 4,165,861; 4,597,584; 4,743,037; 4,746,133; and 9,073,516. In addition to the foregoing, which disclose hydraulic leveling systems, electric leveling jacks have also been used, as shown in U.S. Pat. No. 6,722,635.

### SUMMARY

The leveling jack of the described embodiments functions largely in the same way as existing designs, but the construction and shape of the jack body are modified, and the described embodiments provide improvements from prior designs and how they are mounted. The leveling jack has low-profile top and bottom subassembly portions that are integral to the body housing the cylinder. The top subassembly contains the retract passage and is shaped to assist in mounting an optional light cover accessory. The bottom subassembly includes integrated vertical legs that include mounting apertures for a narrowed mounting location with fewer fasteners. Overall, the leveling jack body has a slimmer profile with reduced hardware and is a more compact and sturdy shape.

During installation, the installer can more simply hold the leveling jack and insert the bolts with the other hand for a more secure hold until the bolts are fully fastened. Aesthetically, the described embodiments provide a narrower mounting profile that takes up less distance/weld space on the I-beam. In some embodiments, a single fastener at least somewhat secures the full weight of each leveling jack during installation instead of needing one fastener per side flange extending from the jack.

In an exemplary embodiment, a leveling jack includes a cylinder assembly including a leveling cylinder that is displaceable between a retracted position and an extended position, a footpad coupled with the leveling cylinder for displacement with the leveling cylinder, a mounting bracket coupled with the cylinder assembly and including mounting legs having apertures therein, and a connecting bracket securable to a structure to be leveled. The connecting bracket is coupled with the mounting bracket via a connector through the apertures in the mounting bracket.

The cylinder assembly may further include an extend port and a retract port positioned on a lower portion of the cylinder assembly.

The footpad may be coupled with the leveling cylinder from a bottom via a bolt and a bushing. The jack may further include a footpad cover securable on a top of the footpad. In some embodiments, the footpad cover may be plastic.

The jack may further include a housing cover securable to the cylinder assembly that houses lighting elements. The housing cover may be shaped in complement to an outer perimeter of the cylinder assembly.

The connecting bracket may be welded to the structure to be leveled.

In some embodiments, the jack includes two of the connecting brackets securable to the structure to be leveled, where the mounting legs of the mounting bracket are positionable between the two connecting brackets, and the leveling jack may further include an elongated bolt inserted through the two connecting brackets and the mounting legs. In some embodiments, the jack may include three of the elongated bolts inserted through the two connecting brackets and the mounting legs.

In another exemplary embodiment, a structure to be leveled on a surface includes a frame including four corners and the leveling jack of the described embodiments positioned at each of the four corners.

In another exemplary embodiment, a leveling system for a recreational vehicle or trailer with a chassis with four corners includes the leveling jack of the described embodiments positioned at each of the four corners.

In still another exemplary embodiment, a method of installing a leveling system in a recreational vehicle or trailer using the leveling jack of of the described embodiments includes the steps of (a) welding the connecting bracket to the recreational vehicle or trailer; and (b) securing the leveling jack to the connecting bracket. The leveling jack may include four of the connecting brackets, and step (a) may be practiced by welding each of the connecting brackets to a corner of the recreational vehicle or trailer. In this context, each of the connecting brackets may include two parts, and step (b) may be practiced by positioning the mounting legs of the mounting bracket between the two parts of each of the mounting brackets, and inserting an elongated bolt through the two parts of each of the connecting brackets and the mounting legs of each of the mounting brackets.

In yet another exemplary embodiment, a leveling jack includes a cylinder housing including a leveling cylinder that is displaceable between a retracted position and an extended position. The cylinder housing has integral top and bottom subassemblies. The top subassembly contains a retract passage for the leveling cylinder, and the bottom subassembly includes integrated vertical legs with mounting apertures. A footpad is coupled with the leveling cylinder for displacement with the leveling cylinder.

### BRIEF DESCRIPTION OF THE DRAWINGS

These and other aspects and advantages will be described in detail with reference to the accompanying drawings, in which:

FIG. 1 is a perspective view of the leveling jack according to the described embodiments;

FIG. 2 is an exploded view of the leveling jack;

FIG. 3 is a perspective view showing an optional housing cover;

FIG. 4 is a perspective view of the leveling jack in use;

FIG. 5 is a top view of the leveling jack in use;

FIG. 6 shows an exemplary alternative or rear bracket in use with the leveling jack; and

FIG. 7 shows an exemplary alternative light card for use with the leveling jack.

### DETAILED DESCRIPTION

The functional components of the leveling jack are similar to those described in U.S. Pat. No. 9,073,516, the contents of which are hereby incorporated by reference.

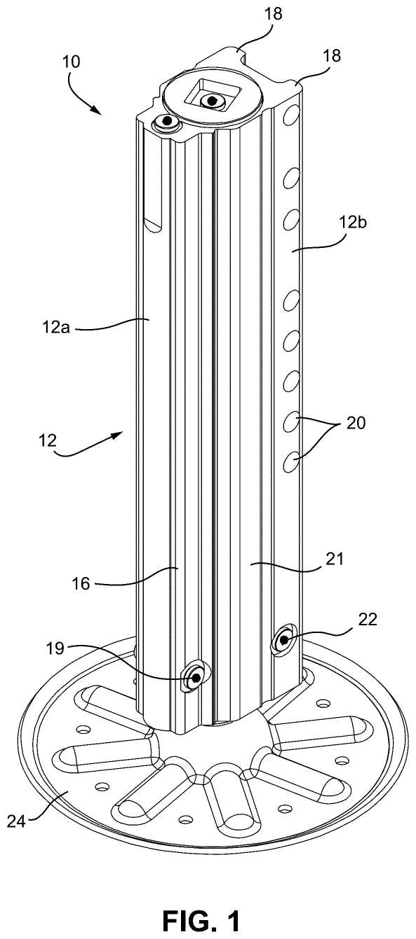

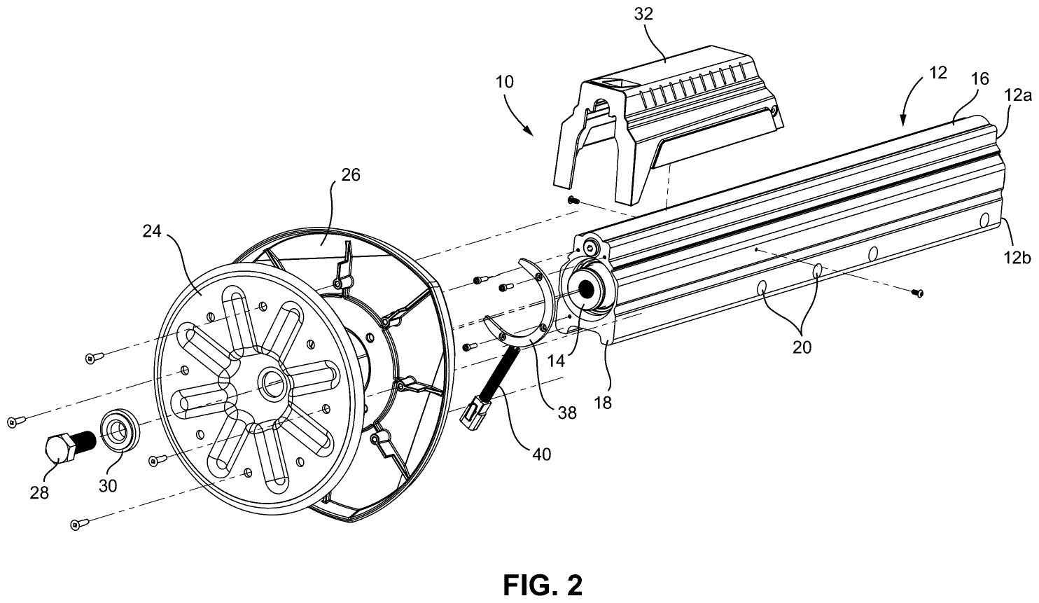

With reference to FIGS. 1-3, the leveling jack 10 of the described embodiments includes a cylinder housing 12 with a leveling cylinder 14 that is displaceable between a retracted position and an extended position. With particular reference to FIG. 2, the cylinder housing 12 includes a top subassembly 12a and a bottom subassembly 12b that are preferably integral parts of the cylinder housing 12.

The top subassembly 12a contains a retract passage 16 for the leveling cylinder 14, and the bottom subassembly 12b defines a mounting bracket with integrated mounting legs 18 that include a plurality of mounting apertures 20. The retract passage 16 for the leveling cylinder 14 is accessible via a retract port 19. The bottom subassembly 12b also includes a port 22 for accessing the extend passage 21 for the leveling cylinder 14. As shown, the ports 19, 22 are positioned on each side of the cylinder housing 12 at the bottom side/lower portion of the jack to operate both extend and retract lines. Typical steel cylinders have one or two ports near the top and one or two ports near the bottom. In contrast with existing devices, the top ports in the present embodiments include recessed profiles rather than the protruding ports from the cap in the existing jacks.

Compared to existing leveling jacks, the cylinder housing 12 has a slimmer profile with reduced hardware and a more compact and sturdy shape.

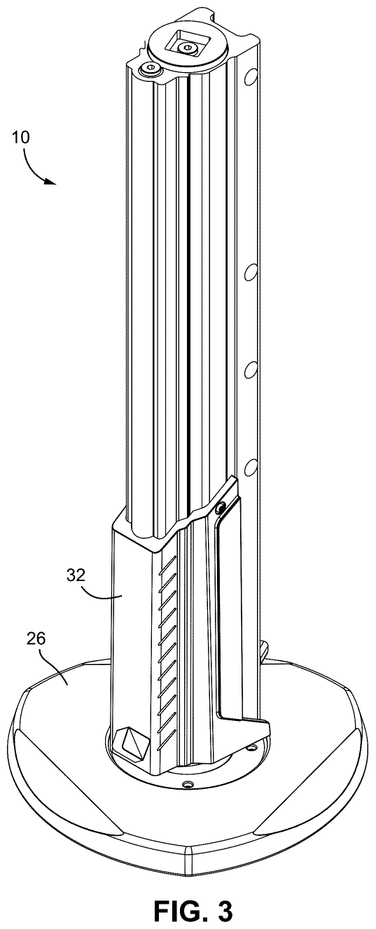

A footpad 24 is coupled with the leveling cylinder 14 for displacement with the leveling cylinder 14. Similar to existing leveling jacks, the footpad 24 engages the ground in use. In some embodiments, the leveling jack 10 may be provided with a footpad cover 26 that fastens to the top of the footpad 24 as shown in FIGS. 2 and 3. The footpad cover 26 may be formed of plastic and sized to fit on the top surface of the footpad 24. The footpad cover 26 may be fastened with four screws from the bottom surface of the footpad 24 into the footpad cover 26. A bolt 28 and bushing 30 are mounted through the bottom of the footpad 24 into the bottom of the assembly to secure the footpad 24 (and the footpad cover 26 if included).

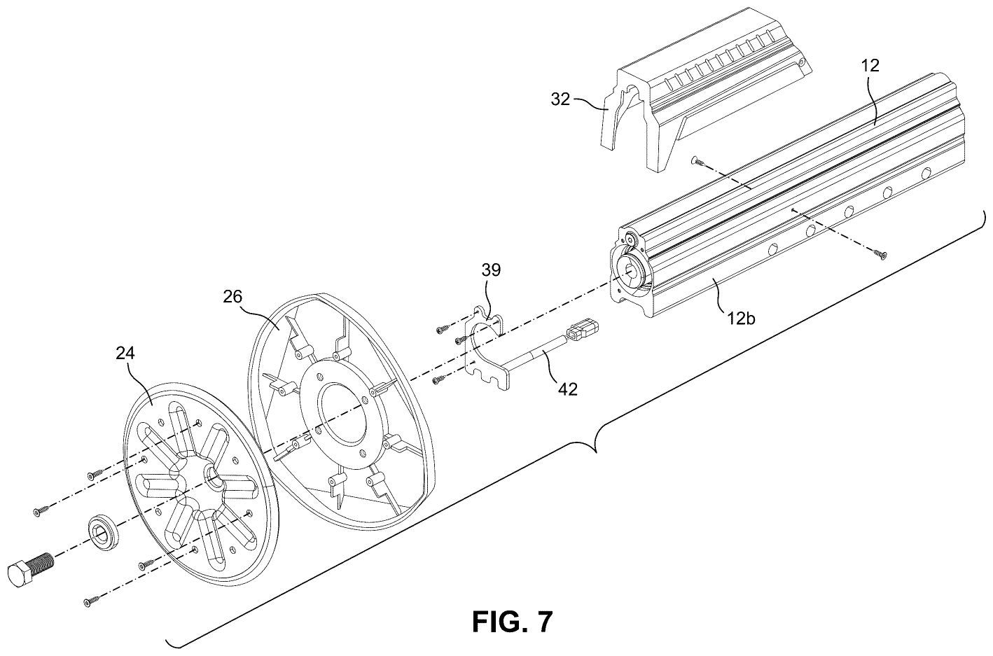

The top subassembly 12a of the cylinder housing 12 may be shaped to assist in mounting an optional light cover accessory in the form of a housing cover 32. The housing cover 32 may be formed of plastic and may fasten to the cylinder housing 12 via machine screws into tapped holes in the cylinder housing 12. As shown, the housing cover 32 is shaped in complement to an outer perimeter of the cylinder housing 12. The housing cover 32 houses LEDs or other like components for optional lighting on the leveling jacks for illumination below the vehicle. A light card 38 may be secured with the leveling jack housing cover 32 and may include wiring and connector 40 that nests with or is substantially concealed by the cylinder housing 12. As shown in FIG. 7, the light card 39 may have a shape that is complementary to the bottom face profile of the cylinder housing 12 so that the light card can be easily mounted inside of the bottom of the housing cover 32. The light card 38 with complementary profile may also secure the wiring and connector 42 in a way that the wiring does not bend and extends directly into the bottom subassembly 12b of the cylinder housing.

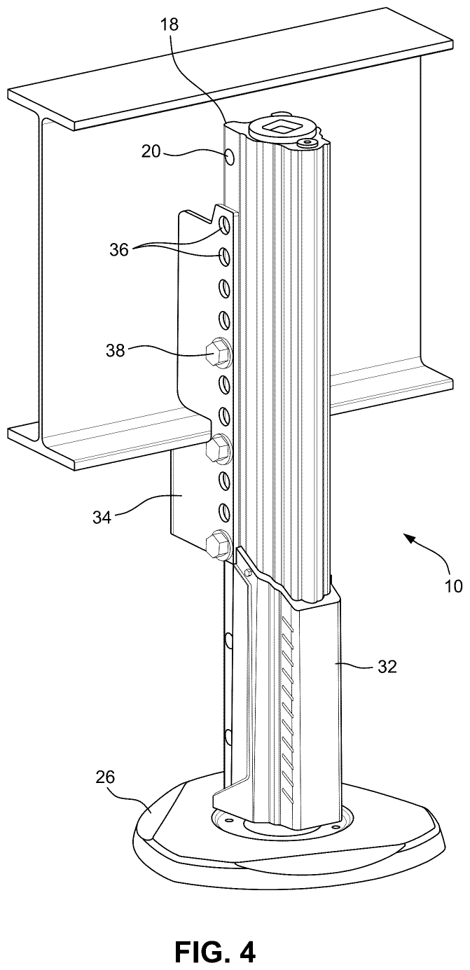

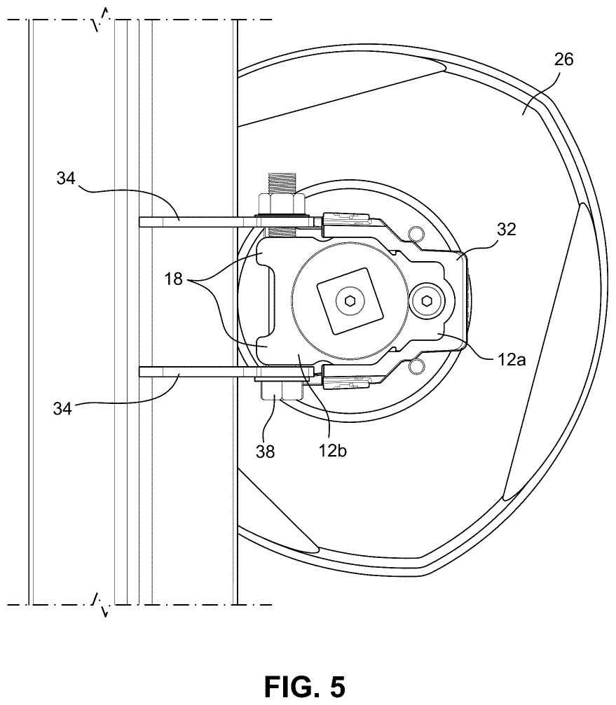

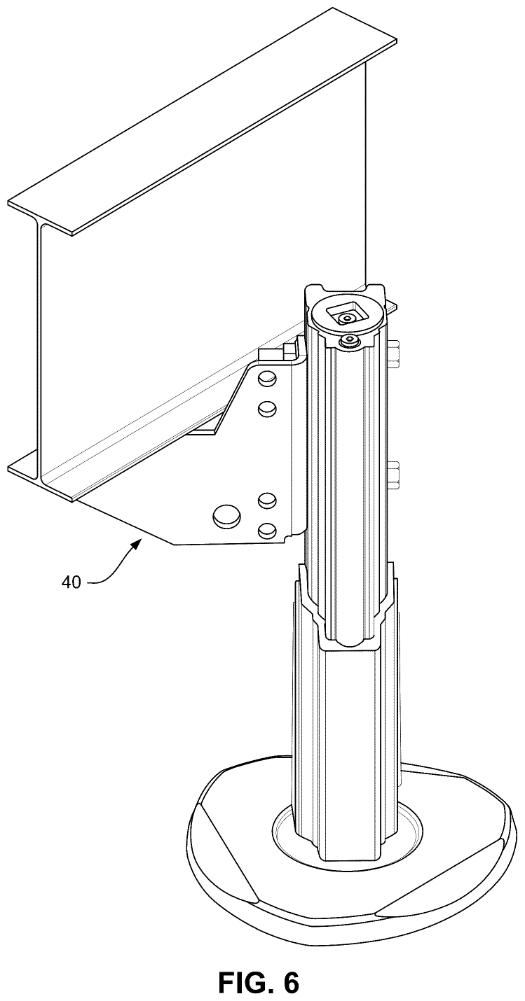

FIGS. 4 and 5 show the leveling jack 10 in use and coupled with an I-beam of a structure to be leveled (e.g., a recreational vehicle or trailer or the like). A connecting bracket 34 is securable to the structure to be leveled. In some embodiments, one or more connecting brackets 34 are welded to the I-beam. In the embodiment shown in FIGS. 4 and 5, two connecting brackets 34 are welded on the vertical web and the bottom flange of the I-beam via a curve or slot in each bracket 34. Apertures 36 in the connecting brackets 34 can be aligned with the apertures 20 in the mounting legs 18. The mounting legs 18 fit between the vehicle-mounted connecting brackets 34, and an elongated bolt 38 is inserted through both brackets 34 and the mounting legs 18 to be fastened on the outer faces of both brackets 34. In some embodiments, the assembly utilizes three bolts 38 per jack. FIG. 6 shows an alternative or rear bracket 40 welded to the bottom flange of the I-beam.

The resulting construction provides a more aesthetic and simplified way to mount the leveling jack 10. Compared to existing leveling jacks, with the leveling jack 10 of the described embodiments, the installer can more simply hold the jack and insert the bolts with the other hand for a more secure hold until the remaining bolts are added and fully fastened. The leveling jack 10 of the described embodiments also requires half the number of fasteners compared to existing leveling jacks because it does not require a pair of fasteners for securing both sides of the jack. Aesthetically, the jack of the described embodiments provides a narrower mounting profile that takes up less distance/weld space on the I-beam. A single fastener at least somewhat secures the full weight of the jack instead of needing one fastener per side flange extending from the jack. Additionally, the streamlined and more centralized leveling jack of the described embodiments eliminates the need for components that extend away from the main cylindrical body, which run a higher risk of unintended damage or breaking.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A leveling jack comprising:
a cylinder assembly including a leveling cylinder that is displaceable between a retracted position and an extended position;
a footpad coupled with the leveling cylinder for displacement with the leveling cylinder;
a mounting bracket coupled with the cylinder assembly and including mounting legs having apertures therein; and
a connecting bracket securable to a structure to be leveled, wherein the connecting bracket is coupled with the mounting bracket via a connector through the apertures in the mounting bracket.

2. A leveling jack according to claim 1, wherein the cylinder assembly comprises an extend port and a retract port positioned on a lower portion of the cylinder assembly.

3. A leveling jack according to claim 1, wherein the footpad is coupled with the leveling cylinder from a bottom via a bolt and a bushing.

4. A leveling jack according to claim 3, further comprising a footpad cover securable on a top of the footpad.

5. A leveling jack according to claim 4, wherein the footpad cover is plastic.

6. A leveling jack according to claim 1, further comprising a housing cover securable to the cylinder assembly, the housing cover housing lighting elements.

7. A leveling jack according to claim 6, wherein the housing cover is shaped in complement to an outer perimeter of the cylinder assembly.

8. A leveling jack according to claim 1, wherein the connecting bracket is welded to the structure to be leveled.

9. A leveling jack according to claim 1, comprising two of the connecting brackets securable to the structure to be leveled, wherein the mounting legs of the mounting bracket are positionable between the two connecting brackets, the leveling jack further comprising an elongated bolt inserted through the two connecting brackets and the mounting legs.

10. A leveling jack according to claim 9, comprising three of the elongated bolts inserted through the two connecting brackets and the mounting legs.

11. A structure to be leveled on a surface comprising:
a frame including four corners; and
the leveling jack of claim 1 positioned at each of the four corners.

12. A leveling system for a recreational vehicle or trailer, the recreational vehicle or trailer including a chassis with four corners, the leveling system comprising the leveling jack of claim 1 positioned at each of the four corners.

13. A method of installing a leveling system in a recreational vehicle or trailer using the leveling jack of claim 1, the method comprising:
(a) welding the connecting bracket to the recreational vehicle or trailer; and
(b) securing the leveling jack to the connecting bracket.

14. A method according to claim 13, wherein the leveling system includes four of the connecting brackets, and wherein step (a) is practiced by welding each of the connecting brackets to a corner of the recreational vehicle or trailer.

15. A method according to claim 14, wherein each of the connecting brackets includes two parts, and wherein step (b) is practiced by positioning the mounting legs of the mounting bracket between the two parts of each of the mounting brackets, and inserting an elongated bolt through the two parts of each of the connecting brackets and the mounting legs of each of the mounting brackets.

16. A leveling jack comprising:
a cylinder housing including a leveling cylinder that is displaceable between a retracted position and an extended position, the cylinder housing having integral top and bottom subassemblies, wherein the top subassembly contains a retract passage for the leveling cylinder, and wherein the bottom subassembly includes integrated vertical legs with mounting apertures; and
a footpad coupled with the leveling cylinder for displacement with the leveling cylinder.

17. A leveling jack according to claim 16, wherein the footpad is coupled with the leveling cylinder from a bottom via a bolt and a bushing.

18. A leveling jack according to claim 17, further comprising a footpad cover securable on a top of the footpad.

19. A leveling jack according to claim 16, further comprising a housing cover securable to the cylinder housing, the housing cover housing lighting elements.

20. A leveling jack according to claim 19, wherein the housing cover is shaped in complement to an outer perimeter of the cylinder housing.

21. A leveling jack according to claim 16, comprising an extend port and a retract port positioned on a lower portion of the cylinder housing.
